(19) United States
(12) Patent Application Publication
(10) Pub. No.: US 2013/0092754 A1
(43) Pub. Date: Apr. 18, 2013

(54) NACELLE FOR A POWER PLANT WITH A VARIABLE-AREA FAN NOZZLE

(71) Applicants: Guillaume Bulin, Blagnac (FR); Patrick Oberle, Verdun Sur Garonne (FR); Nicolas Devienne, Toulouse (FR)

(72) Inventors: Guillaume Bulin, Blagnac (FR); Patrick Oberle, Verdun Sur Garonne (FR); Nicolas Devienne, Toulouse (FR)

(73) Assignee: Airbus Operations SAS, Toulouse (FR)

(21) Appl. No.: 13/554,883

(22) Filed: Jul. 20, 2012

(30) Foreign Application Priority Data
Jul. 22, 2011 (FR) 11 56688

(51) Int. Cl. F02K 1/09

(52) U.S. Cl. CPC F02K 1/09
USPC 239/265.19

(57) ABSTRACT

A power plant includes a nacelle with a bypass turbojet engine having a ducted fan with a low compression ratio. A secondary flow, drawn in and accelerated by the fan, is channeled through a secondary duct installed in the nacelle between the inner surface of the nacelle and the outer surface of the turbojet, toward a fan nozzle. The power plant has at least two moving parts on either side of a vertical plane of symmetry of the nacelle, at least one moving part being able to adopt one of a discrete number of positions, the moving part containing or releasing a portion of the secondary flow, depending on the moving part's position. A control unit controls a different displacement of each of the moving parts between their possible positions in order to create asymmetry of the moving parts relative to the vertical plane of symmetry.

The present invention resides within the field of propulsion systems for aircraft. It concerns more particularly a power plant with a variable-area fan nozzle.

### PREAMBLE AND PRIOR ART

The present invention concerns aircraft with bypass turbojet engines equipped with fans preferably having low compression ratios (typically less than 1.4).

Such a power plant of the bypass turbojet engine type is illustrated in a sectional diagram in FIG. 1 in a configuration conforming to the prior art.

A bypass power plant comprises a nacelle 1, mechanically suspended from the structure of an aircraft by a pylon 2, which extends inside nacelle 1 to support a turbojet 3.

In a very simplified manner, turbojet 3 draws in outside air at an air intake 7 through a ducted fan 6 equipped with an intake cone 13. This fan 6 is driven in rotation with the other stages of a compressor by a turbine (not illustrated).

The air injected by turbojet 3 is separated into two parts: on the one hand a primary flow circulating in a primary duct 4, whose air is used for fuel combustion in a combustion chamber and whose combustion gases, highly accelerated, are ejected towards the rear of turbojet 3 through an exhaust section 5. On the other hand, the remainder of the airflow (the greater part in fact) drawn in and accelerated by fan 6 is channeled through a secondary duct 8 towards a fan nozzle 9.

The compression ratio of fan 6 is defined as the ratio between the air pressure at fan nozzle 9 and the air pressure at air intake 7.

The abovementioned different elements constituting bypass turbojet engine 3 are assumed to be known per se to a person skilled in the art and are therefore not described further here.

Integral with a nacelle 1, a variable-area fan nozzle (also called VAFN) is an air-discharging device for the secondary flow from turbojet 3 through this nacelle 1, thereby allowing an adjustment of the operating point of fan 6 commensurate with improved engine performance.

In fact, the thrust generated by fan nozzle 9 varies according to the outside conditions, engine speed and the ratio of the intake-exit areas. It is therefore possible in this way to optimize engine speed and hence consumption by adjusting the fan nozzle exit area. It is possible, by varying the area of fan nozzle 9 downstream of the fan 6, to improve the operating stability of the power plant, at the same time optimizing fuel consumption and engine noise levels.

This ability to adjust the engine between the different engine speeds such as take-off, landing and cruise has given rise to the invention of different systems and architectures.

Historically, there are two main categories of variable-area fan nozzle, also known as air-discharging devices, for aircraft bypass turbojet engines, which have been the subject of studies and patent applications:
a first category incorporating those devices that use translation motion, along the turbojet axis, of a nacelle ring assembly element such as a thrust reversing cowl for uncovering or covering an opening, usually in the shape of a ring section. Such a device is described for example in Patent Application “Thrust Modulating Apparatus” U.S. Pat. No. 3,797,785 A1 (Rohr Industries, inc. 1973).
a second category covering those devices that comprise at least one pivoting element (also called a hinged door) between an open position and a closed-off position of an orifice made in the turbojet nacelle.

As a general rule, the devices of the first category display numerous disadvantages. For instance, the power needed to activate them is relatively high. It is difficult to say the least to ensure sealing between the moving parts of these devices.

The known devices of the abovementioned second category also display a certain number of disadvantages. For instance, Patent Application FR 2.146.109 of 1973 describes an aircraft bypass turbojet engine containing an annular array of air-discharging devices. Each of these incorporates two pivoting flaps respectively closing the inner opening and the outer opening of an orifice through the turbojet nacelle.

The two pivoting flaps of each device are hinged on the nacelle at one of their upstream and downstream edges, so that they can open by pivoting in opposite directions: either fully, to provide the thrust reversing function, or partially, to provide an air discharging function.

The dual function as a thrust reverser and an air discharging device, together with the independence of the two pivoting flaps, requires the implementation of activating means that are numerous and powerful, such as electric actuators. This is disadvantageous, both in terms of the cost and the weight of these devices. It also leaves little space for any soundproofing linings, which are nevertheless necessary to reduce the noise levels emitted by turbojets.

### DESCRIPTION OF THE INVENTION

The invention concerns a fan nozzle device with a discrete variable area and asymmetrical operation.

More precisely, the invention concerns a nacelle for a power plant with a variable-area fan nozzle, wherein the power plant comprises a nacelle accommodating a bypass turbojet engine incorporating a ducted fan known as a low compression ratio fan, the secondary flow, drawn in and accelerated by the fan, being channeled through a secondary duct installed in the nacelle between the inner surface of said nacelle and the outer surface of the turbojet, towards a fan nozzle,

the nacelle also incorporating:
at least two moving parts located on either side of a vertical plane of symmetry of the nacelle,

at least one of these moving parts being capable of adopting one of a discrete number of positions, said number being greater than or equal to two, the moving part containing or releasing a portion of the secondary flow, depending on the moving part's position, and
means of controlling a different displacement of each of the moving parts between their possible positions in order to create a configurational asymmetry of the moving parts relative to the vertical plane of symmetry of the nacelle.

The aim is to provide the power plant's thrust with an adjustment capability as a function of altitude, in an efficient, simple, reliable, lightweight and energy-saving manner.

The present invention uses a variable-area fan nozzle (VAFN) displaying asymmetry and independence in the discrete positioning of the moving parts in relation to each other.

In a given architecture, the value of a discrete positioning system tolerating asymmetry lies in the fact that a greater number of positions is obtained by designing moving parts which are independent in their movements than when they are synchronized for the sake of maintaining symmetry.

More particularly, this device enables a variable-area fan nozzle (VAFN) with three positions (the intermediate position being asymmetrical), while achieving an automatic control system which has two positions for each air discharging means, and hence is very simple.

According to a preferred embodiment, the moving parts are deployable cowls located inside the secondary duct, in the rear section of the latter, appreciably level with the fan nozzle, said deployable cowls being mobile in translation parallel to longitudinal axis X of the turbojet, the nacelle having openings in the rear section such that these deployable cowls are capable of uncovering or covering these openings.

Advantageously, in this case, at least one deployable cowl is an element in the shape of a nacelle ring segment.

Even more precisely, each deployable cowl merges with the inner surface of the secondary duct in its closed position and constitutes an extension of this surface towards the rear in its open position.

According to a different embodiment, the moving parts are pivoting elements located on the outer surface of the secondary duct, at the rear part of the latter, the nacelle incorporating through openings made in the turbojet nacelle such that these pivoting elements are capable, depending on their open or closed positions, of uncovering or covering these openings.

In one variant, each nacelle supports two deployable cowls, of different dimensions, which are mobile in translation, the two deployable cowls of each nacelle not covering an opening of the same area on each half nacelle, the two hinged doors of each nacelle not covering an opening of the same area on each half nacelle.

in another variant embodiment, each nacelle supports two hinged doors of different dimensions, the inboard hinged door of the inboard half nacelle being smaller than the outboard hinged door of the outboard half nacelle.

The invention also concerns a method for optimizing the engine speed of an aircraft power plant incorporating a nacelle like the one described, wherein:
in cruise flight, the two moving parts of each nacelle are closed,
on take-off, the two moving parts of each nacelle are in the open position,
in climb or descent, the moving part located farthest towards the outer side of the aircraft is open and every other moving part is closed.

Advantageously,
if a deployable cowl remains open in the event of a malfunction in cruise flight, means of controlling the aircraft neutralize the thrust asymmetry with the flight controls,
if an outboard deployable cowl remains closed on take-off or landing, the other deployable cowls remain open to limit the loss of area and thrust asymmetry is rectified with the flight controls.

The invention also concerns a power plant incorporating a nacelle like the one described, and an aircraft incorporating a nacelle like the one described.

### DESCRIPTION OF THE FIGURES

The characteristics and advantages of the invention will be easier to appreciate by virtue of the description that follows, which describes the characteristics of the invention through an example whose application is not restrictive.

The description is supported by the attached figures, which show the following:

FIG. 1 (previously mentioned): a bypass turbojet engine of a conventional type in longitudinal section

FIG. 2: an operating diagram of asymmetrical operation with two cowls closed (position 1),

FIG. 3: an operating diagram of asymmetrical operation with two cowls open (position 2),

FIG. 4: an operating diagram of asymmetrical operation with one cowl open and one cowl closed (position 3),

FIG. 5: an operating diagram in a first variant with one fixed cowl and one cowl closed,

FIG. 6: an operating diagram in the first variant with one fixed cowl and one cowl in the intermediate position,

FIG. 7: an operating diagram in the first variant with one fixed cowl and one cowl open,

FIG. 8: an operating diagram in a second variant with two hinged doors closed,

FIG. 9: an operating diagram in a second variant with one hinged door open and one hinged door closed,

FIG. 10: an operating diagram in a second variant with two hinged doors open,

FIG. 11: an operating diagram in a third variant with four-position operation through cowls in translation,

FIG. 12: an operating diagram in a third variant with four-position operation through hinged doors.

### DETAILED DESCRIPTION OF AN EMBODIMENT OF THE INVENTION

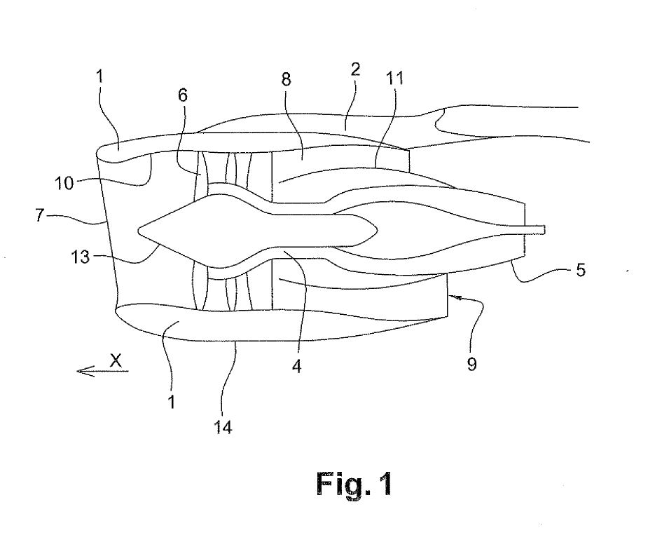

The invention is situated inside a power plant of the bypass turbojet engine type as illustrated in the sectional diagram of FIG. 1, previously described above.

The device that is the subject of the present invention incorporates two independent parts called deployable cowls 20, 21 located on either side of a vertical plane of symmetry of the power plant. Each of these deployable cowls 20, 21 is located inside secondary duct 8, in the rear section of the latter, appreciably facing fan nozzle 9. Each deployable cowl merges with inner surface 10 of secondary duct 8 in a first position known as the closed position, and constitutes an extension of this surface towards the rear in a second position known as the open position.

In an embodiment given here as an example, which is not at all restrictive, such a deployable cowl 20, 21 in a turbojet having a thrust of 30,000 lbf (pounds force) and a bypass ratio of 10:1 takes the shape of a half ring approximately 2 meters in diameter, approximately 40 centimeters in length, with a relative thickness of 5 to 15%.

The device furthermore incorporates means (not illustrated) of moving these deployable cowls 20, 21 independently in translation relative to the structure of fan nozzle 5. For example, a travel of 15 to 30 centimeters will result in a variation of 10 to 30% of the effective exit area of the secondary flow.

Each deployable cowl 20, 21 can occupy two positions, one called “closed” and the other called “open”. Depending on their position, open or closed, deployable cowls 20, 21 contain or release a portion of the secondary flow by causing the exit area of fan nozzle 9 to vary.

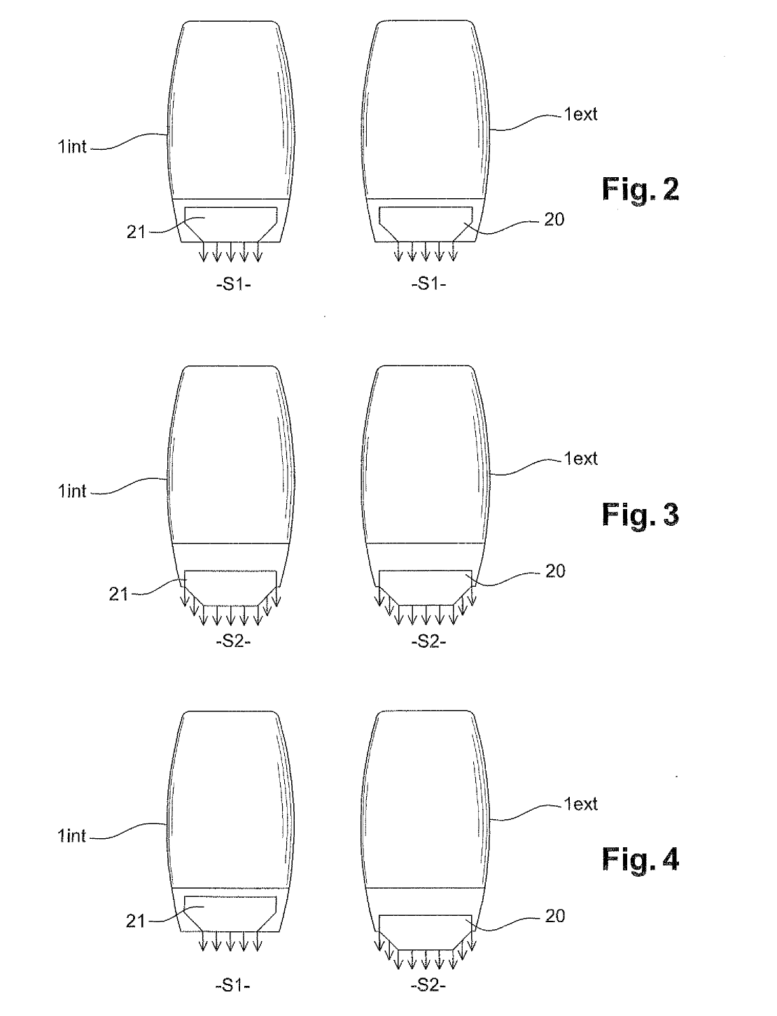

The realization mode described here does not allow any intermediate position, which contributes to the mechanical simplicity of the fan nozzle area adjustment device. If deployable cowls 20, 21 are considered to occupy the same area with respect to the secondary flow, the corresponding exit area of fan nozzle 9 will then adopt three values in the following cases:
Position 1: the two deployable cowls are closed (FIG. 2)
Position 2: the two deployable cowls are open (FIG. 3)
Position 3: one deployable cowl is closed, the other is open (FIG. 4)

As was shown above, the thrust created by fan nozzle 9 varies according to the outside conditions, engine speed and the ratio of the intake-exit areas. It is therefore possible to optimize engine speed and consumption by adjusting the exit area of fan nozzle 9.

In the retracted position, with both deployable cowls 20, 21 closed, fan nozzle 9 offers an exit area S1+S1 (FIG. 2).

In the deployed position, with both deployable cowls 20, 21 open, fan nozzle 9 offers an exit area S2+S2 (FIG. 3).

Finally, in an intermediate position with a first deployable cowl 20 open and a second deployable cowl 21 closed, fan nozzle 9 offers an exit area S1+S2 (FIG. 4).

FIGS. 2 to 4 illustrate the different configurations offered by the asymmetric operation of fan nozzle 9 having a discrete variable area on a nacelle 1 (illustrated as two half nacelles: inboard 1int and outboard 1ext).

Operating Mode

The proposed operating mode is as follows for a twin-engine commercial aircraft:

### Normal Operating Case

In cruise flight, the two deployable cowls 20, 21 in each nacelle are closed, which corresponds to optimum aerodynamic conditions at the speed and altitude under consideration (Position 1).
On take-off, the two deployable cowls 20, 21 in each nacelle are in the open position and discharge a portion of the secondary flow to the rear of fan nozzle 9 (Position 2).
In climb or descent, deployable cowl 20, located more towards the outer side of the aircraft is open (on half nacelle 1ext), and the other is closed (Position 3).

### Malfunction Case

If a deployable cowl remains open in the event of a malfunction in cruise flight, aircraft control means (pilot or autopilot) neutralize the thrust asymmetry with the flight controls.
If an outboard deployable cowl remains closed on take-off or landing, the other deployable cowls, including those in the other engine (case of a twin-engine aircraft) are held in the closed position in order to re-establish thrust symmetry.

Advantages

A system operating with discrete asymmetry offers the advantage of dispensing with an automatic control system at the cowl positions and that of providing three levels of thrust for each nacelle.

This allows actuator control to be simplified and to cater intrinsically for cases of malfunctioning of one of the two deployable cowls (the other remaining available). The present invention therefore provides improved reliability and safety compared with variable-area continuous fan nozzle systems controlled in situ or discrete and symmetrical.

Variants

Several variants satisfying the same functionality, simplicity and robustness criteria can be realized by utilizing the concept of discrete positioning with asymmetrical operation.

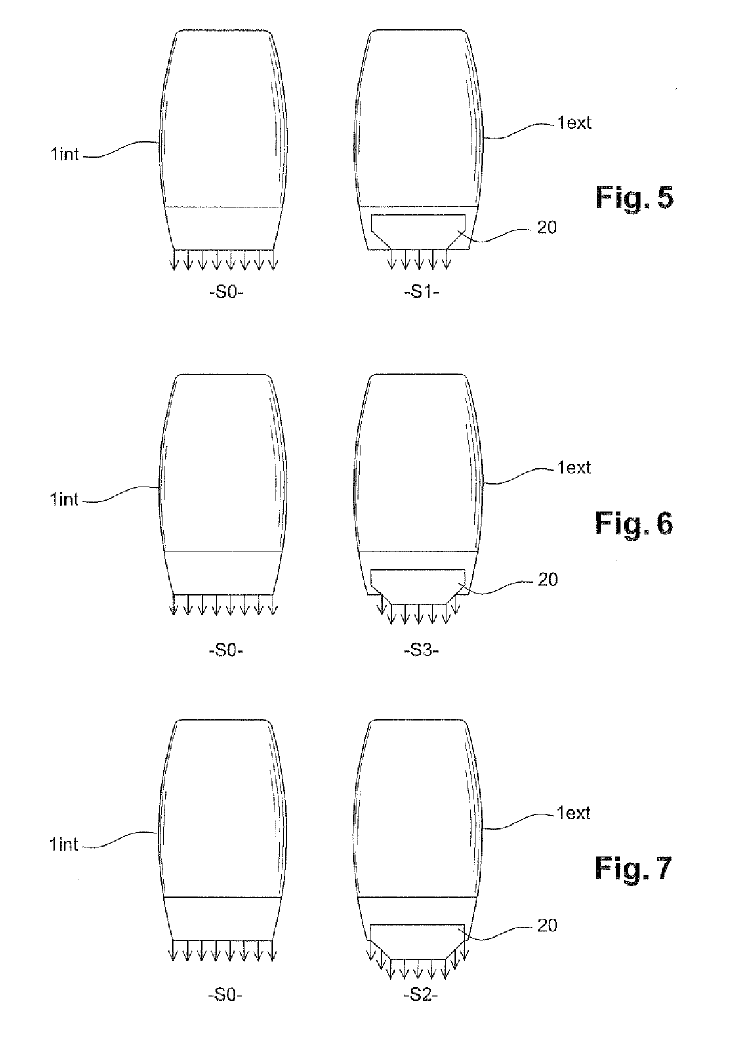

Several innovative solutions are obtained depending on the architecture under consideration “with cowls in translation” (described above), “with a fixed part and a part in translation”, or with “hinged doors”. These concepts are illustrated in FIGS. 5 to 12.

Variant 1: a fixed cowl, supported by inboard half nacelle 1int, and a deployable cowl 20, which is mobile in translation along three positions, and supported by outboard half nacelle 1ext.

This variant is illustrated in FIGS. 5 to 7.

In this variant, the effective exit area from outboard half nacelle 1ext is narrower than that of inboard half nacelle 1int when deployable cowl 20 is closed (FIG. 5).

The effective exit area from outboard half nacelle 1ext is appreciably equal to that of inboard half nacelle 1int when deployable cowl 20 is half open (FIG. 6), and wider when deployable cowl 20 is fully open (FIG. 7).

Variant 2: the two half nacelles 1int, 1ext incorporate independent hinged doors 22int, 22ext.

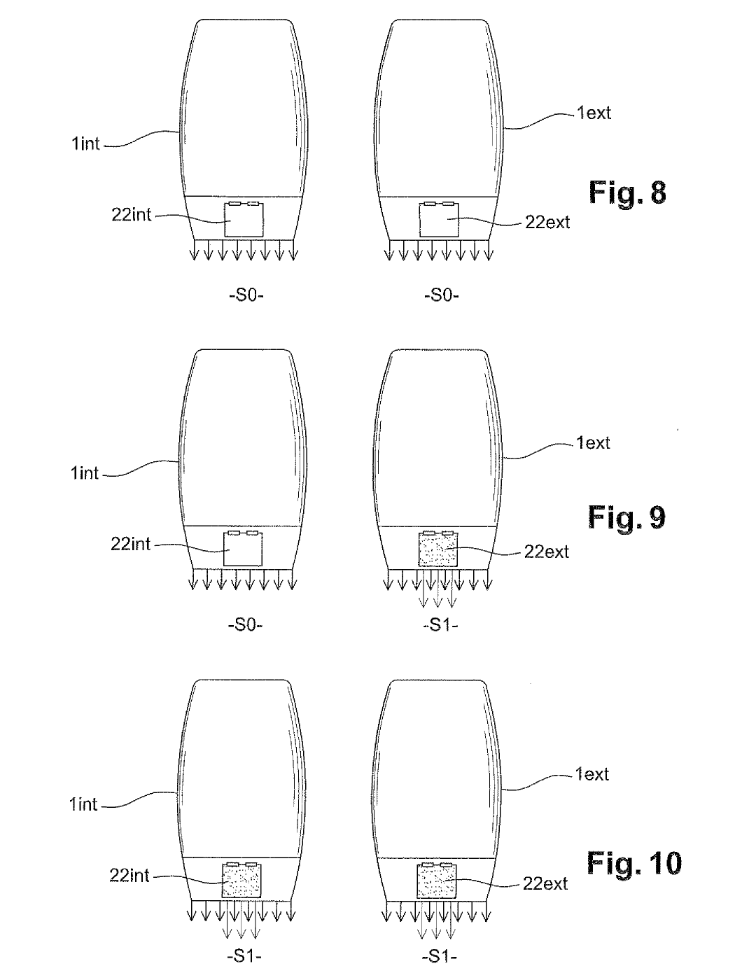

This variant is illustrated in FIGS. 8 to 10.

These hinged doors 22int, 22ext are of the type described in the preamble to the present application.

Once again, the effective exit area created by the nacelle varies among three values according to whether the hinged doors are both closed (FIG. 8), inboard hinged door open and hinged door closed (FIG. 9) or both hinged doors open (FIG. 10). The maximum effective exit area is when both hinged doors are open.

Variant 3: four-position operation

Sub-variant 1: each nacelle 1 supports two deployable cowls, of different dimensions, which are mobile in translation. In this example, which is not at all restrictive, inboard deployable cowl 23int of inboard half nacelle 1int is smaller than outboard deployable cowl 23ext of outboard half-nacelle 1ext.

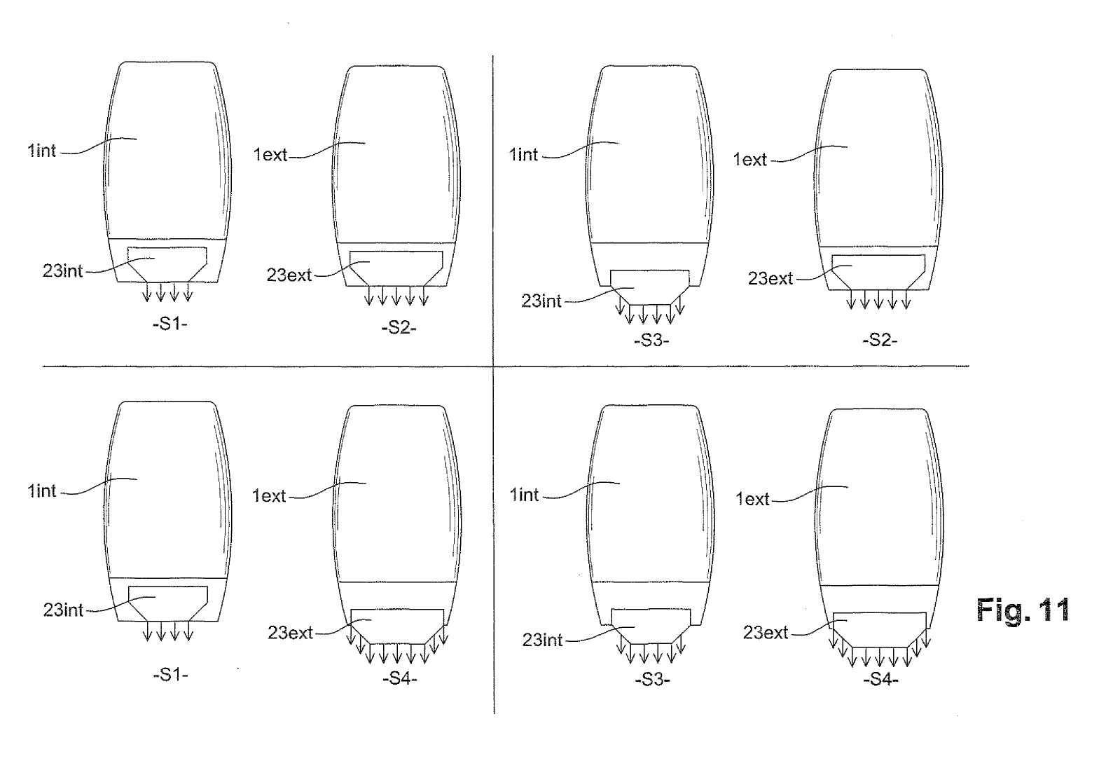

This variant is illustrated in FIG. 11.

### Operation in Flight

In this variant, the two deployable cowls 23int, 23ext in each nacelle do not cover the same area on each half nacelle 1int, 1ext respectively, thereby offering four different combinations. This operating mode is as simple from the point of view of aircraft control and command as the three-position solution and allows the engine speed to be optimized in the event of extra flying (for example stabilized holding flight at low altitude).
Engine speed 1: fan nozzle exit area=S1+S2 (FIG. 11, top left)
Engine speed 2: fan nozzle exit area=S2+S3 (FIG. 11, top right)
Engine speed 3: fan nozzle exit area=S1+S4 (FIG. 11, bottom left)
Engine speed 4: fan nozzle exit area=S3+S4 (FIG. 11, bottom right)

Sub-variant 2: each nacelle 1 supports two hinged doors of different dimensions. In this example, which is not at all restrictive, inboard hinged door 24int of inboard half nacelle 1int is smaller than outboard hinged door 24ext of outboard half nacelle 1ext.

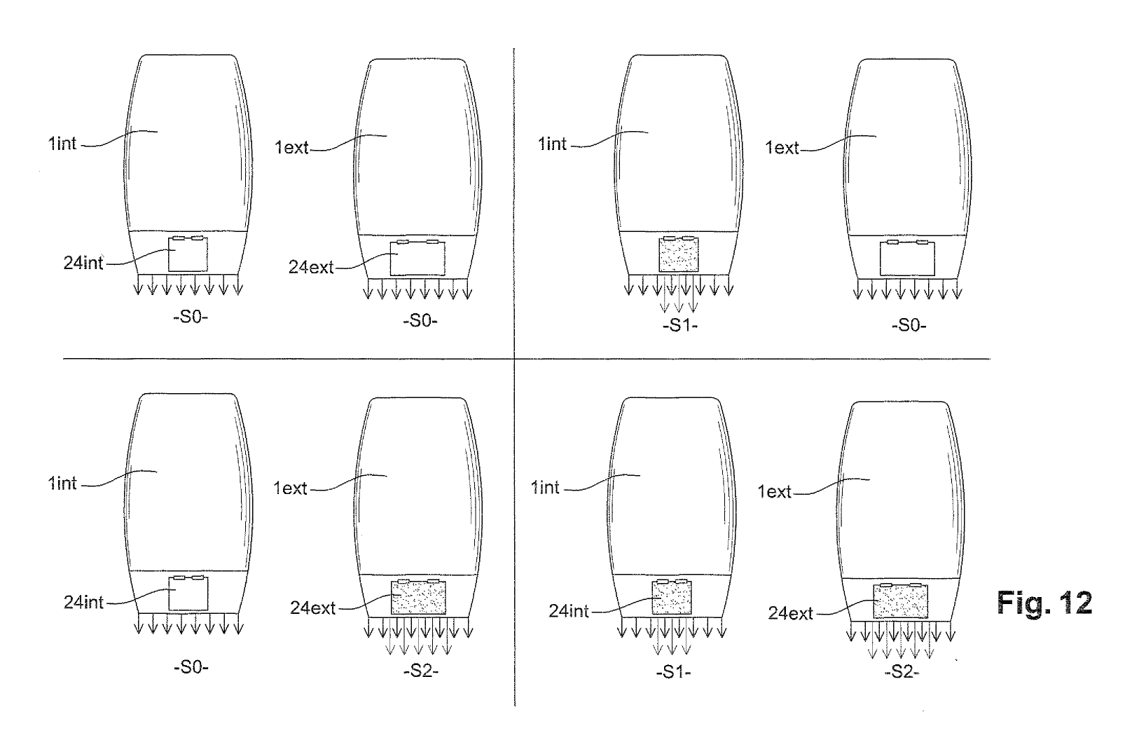

This variant is illustrated in FIG. 12.

### Operation in Flight

As previously, four engine speed settings can be optimized:
Engine speed 1: fan nozzle exit area=S0+S0 (FIG. 12, top left)
Engine speed 2: fan nozzle exit area=S1+S0 (FIG. 12, top right)
Engine speed 3: fan nozzle exit area=S0+S2 (FIG. 12, bottom left)
Engine speed 4: fan nozzle exit area=S1+S2 (FIG. 12, bottom right)

Variant 4: a fixed part and a continuous moving part (variant not illustrated)

Another variant consists of a half nacelle incorporating a fixed cowl and of the other half nacelle incorporating a deployable cowl, which is mobile in translation in a continuously controllable manner, and no longer just according to a number of discrete positions.

This solution is a compromise between discrete and continuous positioning, although always in asymmetrical operation. This offers certain advantages of easy controlling and design simplicity with continuous automatic control.

In another variant embodiment, each nacelle supports two hinged doors of different dimensions, the inboard hinged door of the inboard half nacelle being larger than the outboard hinged door of the outboard half nacelle. The operating principle is the same in this case.

1. A nacelle for a power plant with a variable-area fan nozzle, the power plant comprising a nacelle (1) accommodating a bypass turbojet engine (3) incorporating a ducted fan (6), the secondary flow, drawn in and accelerated by the fan (6), being channeled through a secondary duct (8) installed in the nacelle (1) between the inner surface of said nacelle (1) and the outer surface of the turbojet (3), towards a fan nozzle (9), the nacelle also incorporating;
at least two moving parts located on either side of a vertical plane of symmetry of the nacelle, said plane of symmetry defining two half nacelles;
at least one of these moving parts being capable of adopting one of a discrete number of positions, said number being greater than or equal to two, the moving part containing or releasing a portion of the secondary flow, depending on the moving part's position, and
means of controlling a different displacement of each of the moving parts between their possible positions in order to create a configurational asymmetry of the moving parts relative to the vertical plane of symmetry of the nacelle,
wherein, since the two half nacelles each incorporate, in the rear section, at least one opening capable of being covered by a moving part, and since the openings in one half nacelle have different dimensions from those in the other half nacelle, each moving part has a dimension appropriate to the opening with which it is associated.

2. The nacelle as claimed in claim 1, wherein the moving parts are deployable cowls (23int, 23ext) located inside secondary duct (8), in the rear section of the latter, appreciably facing fan nozzle (9), said deployable cowls being mobile in translation parallel to longitudinal axis X of turbojet (3) in order to uncover or cover the openings with which they are associated.

3. The nacelle as claimed in claim 2, wherein at least one deployable cowl is an element in the shape of a nacelle ring segment.

4. The nacelle as claimed in claim 2, wherein each deployable cowl merges with the inner surface (10) of secondary duct (8) in its closed position and constitutes an extension of this surface towards the rear in its open position.

5. The nacelle as claimed in claim 1, wherein the moving parts are hinged doors (24int, 24ext) located on the outer surface of secondary duct (8), at the rear section of the latter, in such a way, depending on their open or closed position, as to uncover or cover the openings with which they are associated.

6. A method for optimizing the engine speed of an aircraft power plant incorporating a nacelle as claimed in claim 1 wherein:
in cruise flight, the two moving parts (20, 21) of each nacelle are closed,
on take-off, the two moving parts (20, 21) of each nacelle are in the open position,
in climb or descent, the moving part (20) located farthest towards the outer side of the aircraft is open and every other moving part is closed.

7. The method as claimed in claim 6, wherein:
if a deployable cowl remains open in the event of a malfunction in cruise flight, means of controlling the aircraft neutralize the thrust asymmetry with the flight controls,
if an outboard deployable cowl remains closed on take-off or landing, the other deployable cowls are held in the open position and means of controlling the aircraft neutralize the thrust asymmetry with the flight controls.

8. A power plant, which incorporates a nacelle as claimed in claim 1.

9. An aircraft, which incorporates a nacelle as claimed in claim 1.

10. The nacelle as claimed in claim 3, wherein each deployable cowl merges with the inner surface (10) of secondary duct (8) in its closed position and constitutes an extension of this surface towards the rear in its open position.
